(19) United States
(12) Patent Application Publication
(10) Pub. No.: US 2026/0339136 A1
(43) Pub. Date: Oct. 29, 2026

(54) LAMINATED PANE WITH INTEGRATED FUNCTIONAL ELEMENT

(71) Applicant: SAINT-GOBAIN SEKURIT FRANCE, Thourotte (FR)

(72) Inventors: Varun RAMESH KUMAR, HERZOGENRATH (DE); Valentin SCHULZ, HERZOGENRATH (DE); Stefan HERTEL, HERZOGENRATH (DE)

(21) Appl. No.: 19/107,315

(22) PCT Filed: Aug. 9, 2023
(86) PCT No.: PCT/EP2023/072073

§ 371 Date: Feb. 27, 2025

(30) Foreign Application Priority Data
Aug. 31, 2022 (EP) 22193200.7

(51) Int. Cl. G02F 1/133; B60J 3/04; G02F 1/137

(52) U.S. Cl. CPC G02F 1/13306; B60J 3/04; G02F 1/137

(57) ABSTRACT

A laminated pane has an outer pane with an outer side I and an inner side II and an inner pane with an outer side III and an inner side IV, which are bonded to one another via a thermoplastic intermediate layer, wherein at least one electrical functional element is integrated in the laminated pane, which has at least one film with at least one functional surface, on which at least one functional layer with at least one electrical component is arranged, wherein at least one electrical module is formed on the functional surface and/or a decorative layer is formed on the film, and/or which is or includes at least one in-mold electronics component, wherein the electrical module or the IME component is at least partially arranged in a recess or cutout prefabricated for this purpose or in a setback of the inner pane and/or the intermediate layer.

The invention relates to a laminated pane with an integrated electrical functional element, and to a method for producing such a laminated pane and its use.

A large number of panes are used in the field of vehicle technology. There is an increasing desire to integrate different functions into the panes. For example, attempts are increasingly being made to integrate electrical functional elements, such as sensors, e.g. rain sensors, lighting sensors, distance sensors, etc., or operating elements, such as touch switches, proximity switches, lighting and display elements or other functional elements, for example for driver assistance systems and/or for infotainment purposes, into the panes. Here, the space requirements of the functional elements and components, for example, along with the often complex fabrication processes or the less aesthetic appearance of the resulting panes are limiting factors.

Functional glazing is already widely used in buildings and/or vehicles. DE 19927683 C1 discloses a laminated glass pane comprising at least two glass panes and a transparent laminated layer connecting them and with a solar protection layer substantially reflecting rays outside the visible spectrum of solar radiation, in particular infrared rays. The laminated glass pane is provided with a further transparent, substantially heat-reflecting coating (low-E layer) on its surface facing the interior, which is spatially separated from the solar protection layer.

Windshields are also known into which a sun shade in the form of a functional element with electrically controllable optical properties is integrated, in particular with electrically controllable transmission or scattering behavior. The driver can thus control the transmission behavior of the windshield itself with respect to solar radiation, and the conventional mechanical sun shade can be dispensed with.

Electrically adjustable sun shades are also used in glass roofs of motor vehicles. In particular in the case of large-area panoramic glass panes, there is a need to variably control the transmission of the pane. Depending on the position of the sun, there is a need here for only partial regions of the pane to be masked out, or also to switch the complete surface to be non-transparent for privacy in the parked vehicle.

Such an electrically switchable functional element for realizing adjustable sun shades is a so-called polymer dispersed liquid crystal (PDLC) functional element. The active layer contains liquid crystals which are embedded in a polymer matrix. If no voltage is applied, the liquid crystals will be aligned in an unordered manner, which results in strong scattering of the light passing through the active layer. If a voltage is applied to the planar electrodes, the liquid crystals will align in a common direction and the transmission of light through the active layer is increased. The PDLC functional element acts not so much by reducing the total transmission as by increasing the scattering to ensure glare protection.

Windshields with electrically adjustable sun shades are known, for example, from DE 102013001334 A1, DE 102005049081 B3, DE 102005007427 A1 and DE 102007027296 A1. DE 102010021563A1 describes a windshield with an electrically adjustable sun shade that can be switched in partial regions, wherein the darkening of the individual elements can be controlled via a capacitive sensor arrangement in the edge region of the sun shade.

The electrical contacting of electrically controllable functional elements is usually effected via conductor bars (also referred to as “bus bars”), which are applied to the flat electrodes in the edge region of the functional element and contact them electrically conductively. By connecting the bus bars to an external voltage source, for example via flat conductors attached to the bus bars, a voltage is applied to the flat electrodes and the active layer of the functional element is switched.

U.S. Pat. No. 8,519,362 B2 describes a HUD system that is installed in a car. It is based on a laminated pane, the HUD function of which stems from a layer made of luminophorous material. U.S. Pat. No. 7,230,767 B2 describes a display system in a car windshield, whereby a light-emitting material that projects the image to the driver is used. The image is a virtual image that is focused meters away from the driver's eyes and the windshield.

WO 2020/143996 A1 discloses a device and a method for displaying a digital image on a geometric and photometric non-trivial surface. In particular, the document discloses projecting an image onto a windshield that comprises a laminated glazing with a switchable liquid crystal layer.

A production method for a HUD system that is integrated into a laminated glass pane is described in EP 2 883 693.

WO 2017/157626 A1 discloses a windshield with a functional element with electrically controllable optical properties.

In WO 2018/215106 A1, a laminated glass pane is disclosed having a first glass layer and a second glass layer, wherein at least a first electrically conductive structure and a second electrically conductive structure are arranged between the first glass layer and the second glass layer, wherein the first electrically conductive structure and the second electrically conductive structure are arranged at a distance from one another, wherein the first electrically conductive structure at least partially overlaps the second electrically conductive structure in a perpendicular alignment in relation to the first glass layer, wherein the first electrically conductive structure is assigned to a first electrical element, wherein the first electrical element is a capacitive sensor.

WO 2022/152511 A1 describes a glazing with an operating device fastened to the outside thereof, wherein the operating device has at least one operating element that is arranged on the operating side, wherein the operating device is arranged on the outside of the pane of the glazing with a fastening side facing away from the operating side. The operating device comprises one or more electronic components and a power supply unit. The operating device also comprises a thermally deformed film with a decorative side and an underside opposite the decorative side. The decorative side constitutes the operating side of the operating device. A functional layer with at least one electronic component is printed on the underside of the thermally deformed film. A body is arranged on the underside of the film and/or the functional layer, which is non-detachably connected to the film and/or the functional layer, for example via a connection created by injection molding. The operating device is preferably an in-mold operating device, which is produced in a so-called in-mold electronics (IME) method. This IME production method is already widely used in industrial and automotive electronics.

US 2019/134954 A1 discloses a luminous signal glazing along with a vehicle with such glazing and the production of such glazing.

US 2019/291388 A1 discloses a vehicle glazing with a light indicator.

WO 2018/122770 A1 discloses a laminated automotive glazing with a darkening region that is created by printing the darkening onto a film laminated between at least two layers of plastic intermediate layers or directly onto the intermediate layer instead of printing and burning an enamel frit onto the glass.

WO 2022/268691 A1 discloses a laminated pane with a functional film with an opaque print, wherein the functional film can be, for example, a HUD film, a display film, an optical multilayer film, a film with a coating reflecting infrared radiation or a functional film with electrically switchable optical properties.

The object of the present invention is to provide an improved laminated pane with at least one electrical functional element, wherein the electrical functional element is integrated into the laminated pane and, in addition to providing one or more functionalities, an attractive, uniform and aesthetic appearance of the laminated pane is simultaneously made possible. The laminated pane with the integrated functional element should be easy and cost-effective to produce, even in industrial series production.

The task of the invention is achieved with respect to the laminated pane and with respect to the method with the features of the independent claims. Expedient embodiments result from the respective dependent claims.

According to the invention, a laminated pane, in particular for a vehicle, is provided with an outer pane with an outer side I and an inner side II, and an inner pane with an outer side III and an inner side IV, which are bonded to one another via a thermoplastic intermediate layer, wherein at least one electrical functional element is integrated into the laminated pane, which
has at least one film with at least one functional surface, on which at least one functional layer with at least one electrical component is arranged, wherein at least one electrical module is formed on the functional surface and/or a decorative layer is formed on the film and/or which
is or comprises at least one in-mold electronics (IME) component, wherein the electrical module and/or the IME component is at least partially arranged in a recess or cutout prefabricated for this purpose or in a setback of the inner pane and/or the intermediate layer.

An integrated functional element is understood to mean at least one electrical functional element that is introduced into the laminated pane and laminated in such a way that it is either completely embedded between the outer pane and the inner pane, preferably between the inner pane and the intermediate layer, or the electrical functional element is formed and arranged at least substantially flush and even with the inner side IV of the inner pane.

According to the invention, it is thus possible to provide a large number of functions, integrated into the laminated pane, with optimized installation space, while at the same time maintaining an attractive, aesthetic appearance of the laminated pane. An electrical functional element according to the invention is expediently connected to a power supply device.

In its preferred use as a vehicle pane, the laminated pane is suitable for separating a vehicle interior from an external environment. The laminated pane can be used in a variety of ways. For example, it can be a roof pane, a windshield, a rear window, a side pane or another laminated pane that defines the vehicle interior.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors. The laminated pane is produced by lamination using, for example, vacuum bag methods, vacuum ring methods, calendering methods, vacuum laminators, autoclave methods or combinations thereof. The outer pane and inner pane are usually connected under the effect of heat, vacuum and/or pressure. The so-called autoclave method, for example, is carried out at an elevated pressure of approximately 10 bar to 15 bar and temperatures of 130 °C to 145 °C for approximately 2 hours.

In the sense of the invention, the outer side refers to the main surface which is intended to face the external environment when installed. In the sense of the invention, the inner side means the main surface which is intended to face the interior when installed. The outer side can also be referred to as the outer-side surface. The inner side can also be referred to as the interior-side surface.

In one design, the electrical functional element can be configured as a film that has at least one functional surface with a functional layer with at least one electrical component and a decorative layer. The film is preferably a polyester or polycarbonate film. Functional surface is understood to mean that a functional layer with electronics is applied to one surface side of the film and the electronics comprise at least one electronic component. The film is also referred to below as a functional film. The electrical component of the functional layer can be part of an operating element, for example. For the purposes of the present invention, an operating element is to be understood to mean a region of the user interface, in particular a film surface, with an associated component, which executes a switching function by pressing (touching) or pressing and a sliding movement. Such operating elements are well known.

In one embodiment, the electrical functional element can be designed, for example, as an operating device with one or more operating elements and, optionally, further components, for example with lighting means.

The functional layer can, for example, be applied to the functional surface of the film using a printing method or can be a further film that is thermally bonded to the functional surface of the film or bonded by means of an adhesive layer. It is also possible that the functional film is provided with a functional layer on both sides.

A decorative layer is understood to mean that at least a partial region of the film, on the functional surface or on the surface of the film opposite the functional surface, is provided with a decorative or functional decoration, for example with color, graphics, text, symbols or patterns. This can be carried out simultaneously or subsequently to the creation, for example printing, of the electrical components. For example, graphics and conductor tracks can be screen printed with functional inks on thin polyester or polycarbonate films. It is also possible to apply the desired or required decorative elements to a carrier film by means of screen or digital printing and to bond this decorative film to the functional film prior to or during lamination to form the laminated pane. An analogous method is known in the field of in-mold decoration of integrated electronic components, wherein, however, according to the invention, the forming and back-molding of the films to produce a body is replaced by the lamination process to form a laminated pane. With regard to an embodiment of the electrical functional element as an integrated operating device, a visual and intuitively operable user interface, for example with touch buttons (touch switches) or sliders (sliding switches), can be created and provided simply and cost-effectively in this way. Accordingly, it is provided that the decorative layer is substantially applied to the side facing an observer and, if applicable, a potential operator (operating side) and is arranged in the laminated pane, for example in the direction of a vehicle interior.

As an alternative or in addition to a decorative layer, an electrical module, in particular an electrical 3D component, is arranged on the functional surface. This is at least partially arranged in a prefabricated recess or cutout adapted for this purpose or in a setback of the inner pane and/or the intermediate layer.

In this context, a recess is understood to mean a cavity in the inner pane or the intermediate layer, which is provided and suitably designed to accommodate the electrical module as flush as possible, in particular to compensate for the spatial height of the electrical module. As a result, on the one hand, a secure storage and fastening is achieved and the inner pane forms the surface facing the interior, so that the electrical module and the entire electrical functional element are protected from environmental influences. On the other hand, the recess at least partially compensates for the spatial height of the module and prevents the laminated pane, in particular the inner pane, from breaking during the lamination process.

A cutout is understood to mean an opening passing through the inner pane and/or intermediate layer, for example a through-hole through the inner pane, which is provided prior to use in the fabrication process. The opening is provided to accommodate the electrical module or the IME as flush as possible. In one embodiment, the electrical module or the IME component can then form a surface, for example a user interface to the interior, in particular to the vehicle interior. It is also possible, if required, to lead and provide connection elements out of the inner pane of the laminated pane. Alternatively, it is also possible that the electrical module in the spatial height does not fill the cutout up to the inner side of the inner pane. The cutout can then optionally, be subsequently filled with a transparent plastic following the lamination process to form a flush and flat surface with the inner side of the inner pane, and be closed in a gas-tight manner. In this way, the electrical module can be protected from external influences. For example, an opening to the interior can also be closed in the laminated pane by means of a subsequent and, if applicable, spatially and/or temporally limited lamination. A PVB film used for this purpose can have a thickness of 50 μm to 0.38 mm, for example. Alternatively, a transparent plastic could be used to close the opening.

A setback is defined as a lateral offset of the inner pane and/or the intermediate layer from the dimensions of the corresponding edge of the outer pane in portions or regions. Such a setback can be created, for example, by cutting or in other conventional manners. Here as well, the dimensions are expediently adapted to the respective space requirements of the electrical module or an IME component, so that secure storage and fastening along with a visually appealing appearance can be achieved in the lamination process.

Alternatively or additionally, the electrical functional element is or comprises an in-mold electronics (IME) component, wherein this is arranged, as previously described, at least partially in a prefabricated recess or cutout or in a setback of the inner pane and/or the intermediate layer adapted for this purpose. The invention describes for the first time the integration of IME components into a laminated pane. The IME component can advantageously be integrated into the laminated pane in the usual lamination process, i.e. it can be inserted and fastened. Advantageously, a further process step for insertion or fastening to the laminated pane as a separate, functional component is not required.

In principle, IME is a known technology that is now widely used in industrial and automotive electronics for the fabrication of electronic devices and components. With the advent of more ductile materials and more conductive inks that can withstand casting at high temperatures, it became possible to forgo rigid circuit boards and apply conductive tracks directly onto the plastic surfaces of electronic devices. As a result, it is possible to fabricate flexible film circuit boards and 3D structural electronics with resistors, integrated circuits, sensors, antennas and LEDs, for example, that can conform to the curved shapes of, for example, the housings of various devices. The optimum adaptation to the embodiment of the laminated pane according to the invention, for example adapted to the curvature of the panes common in the vehicle sector, along with various design specifications and requirements, is easily possible when providing and integrating an IME component. Components of such integrated electronics can be, for example, electrical circuits, such as flexible printed circuit boards and wiring, lighting, operating elements, such as printed capacitive touch operating elements, along with sensors of all kinds, such as ultrasonic radar, IR, inductive and capacitive sensors, for example ambient light, shock, stress, proximity and acceleration sensors, antennas and integrated circuits. An attractive design and integrated, versatile functionality of the laminated panes can advantageously be provided in a wide range of variations, optimized according to the invention. By reducing the number of parts and moving components, the risk of failure is reduced, as are production and assembly costs and, if applicable, downstream maintenance costs. The integration of customized IME components and the electronics embedded in them can not only be configured to be aesthetically pleasing, but they are also functional and particularly reliable. According to the invention, a laminated pane can thus be provided in which, for example, a compact operating device is integrated and which satisfies the operating device's demanding design specifications in relation to placement, accessibility and functionality. In particular, it is possible to integrate human-machine interfaces (HMI), for example with gesture control, touch switches/touch control, along with ambient or reading lighting, designs for shy-tech displays into the laminated pane. In a less preferred embodiment, an IME component can also be positioned downstream of the lamination process in a cutout or in a lateral setback of the laminated pane and fastened using an acrylate adhesive, for example.

The integrated IME component can, for example, comprise a touch control and a user interface. Capacitive touch control is already used in many known IME applications. This interface replaces pressing a physical button with the touch of a finger. The conductor tracks on the circuit board are located below the point of contact and monitor the change in the electrostatic field. When touching the capacitive plate, for example the inner side of the inner pane, or the user interface of the integrated IME component itself in the laminated pane, a small charge is drawn to the point of contact-our finger acts as a functional capacitor. In vehicles, such interfaces are used, for example, to switch on the headlights or the power supply or to adjust the volume.

In one embodiment, the electrical functional element is formed and/or connected with conductor tracks, electrical circuits, operating elements, sensors, antennas and/or integrated circuits, illuminants.

In another embodiment, a surface-mounted electrical component (SMD), preferably selected from the group consisting of LED, OLED, diode, integrated circuit, resistor, capacitor, is arranged on the functional surface of the electrical functional element as an electrical module. Particularly preferably, the surface-mounted electrical component (SMD) is selected from the group of integrated circuits, resistors and capacitors.

In a further embodiment, the electrical module is a system-in-package (SiP) chip or a system-on-chip (SoC). System-in-package (SiP) refers to semiconductor circuits that combine various chips in a package to form a complete electronic system. With such a SiP package, all functions that are normally performed by individual chips are combined in a single chip. Since chips already exist for most functionalities, SiP technology combines them in a single package. These can be analog and digital functions, such as those of comparators or amplifiers, logic circuits or memory units, input/output systems (I/O) and digital signal processing (DSP). In a system-in-package, all individual chips are stacked on top of one another to form a package. These three-dimensional chips (3D ICs) lead to significant space savings and lower costs. The advantages of SiP technology lie in its flexibility, wherein active and passive components and analog and digital circuits can be combined to form a system. The combination is independent of the technology and allows the use of CMOS technology, silicon-germanium (SiGe), gallium arsenide (GaAs) and other compound semiconductors. The system-on-chip, on the other hand, is a single chip that contains all the desired electronics. With these designs, a large number of functions can be realized in a compact design and integrated into the laminated pane.

In a particularly preferred embodiment, the electrical module is a system-in-package (SiP) or a system-on-chip (SoC), wherein the chip is arranged in a recess, a cutout or a setback of the inner pane and/or the intermediate layer.

In a preferred embodiment of the laminated pane according to the invention, the electrical functional element is at least one in-mold electronics (IME) component. The electronics (IME) component is preferably arranged in a cutout prefabricated for this purpose or in a setback of the inner pane.

In a further embodiment of the laminated pane according to the invention, the electrical functional element is connected in particular via a connection, in particular a data connection, to a control unit and/or the on-board electronics, in particular the vehicle electronics. This can be a wired or cabled data connection or a wireless data connection. For example, the electrical functional element can be connected via connecting cables, conductor bars, in particular a CAN bus, LIN bus, MOST bus, FlexRay or automotive Ethernet.

In another embodiment, the laminated pane according to the invention can comprise at least one electrically switchable layer that is functionally connected to the electrical functional element. In particular, the electrical functional element can be suitably designed for controlling the electrically switchable layer. As a result, a switchable laminated pane is provided, which comprises one or more electrically switchable layers with two functional states. This can be a layer, e.g. a liquid crystal layer, for example a PDLC or LC layer, or a layer with SPD (suspended particle device) or guest host technology, which can be switched between a transparent and a translucent or opaque state, for example. It can also be an electrochromic or luminescent layer, e.g. an OLED layer. With guest host technology, molecularly doped polymers are used in the field of optoelectronics. These guest-host systems consist of a polymer matrix in which a low-molecular, function-bearing compound is dissolved. Because the actual function is taken over by the mixed-in guest molecules, the systems can be easily adapted to a specific application, without having to chemically modify the polymer itself. Such materials are already being used, for example, in optical information technology and sensor technology, as systems for holographic storage, as non-linear materials for frequency doubling and electro-optical modulation or as an active layer in organic light-emitting diodes (OLEDs).

The electrically switchable layer with two functional states can be formed over the entire surface or over part of the surface. Such layers are expediently connected in the laminated pane via conductor bar rails (bus bars). The electrically switchable layers can also comprise or realize other functions, for example as heating layers.

In a further embodiment of the laminated pane according to the invention, it is provided that the electrical functional element is functionally connected to at least one further electrically switchable component or module, in particular to electrical circuits, operating elements, sensors, antennas, imaging and image-recording modules, such as cameras, displays or projectors, and/or acoustic modules, or lighting elements.

The laminated pane according to the invention can comprise one or more functional layers, in particular an infrared ray-reflecting layer, an infrared ray-absorbing layer, a low-E layer, a UV ray-reflecting layer, a UV ray-absorbing layer. Preferably, these infrared ray-and UV ray-reflecting or absorbing layers are arranged spatially behind the electrical functional element when viewed through the laminated pane in the direction of view from the inner pane to the outer pane. In this way, they can advantageously protect the electrical functional element from the harmful effects of strong sunlight. A low-E coating is typically applied to the inner side of the inner pane. The functional layers mentioned above also contribute to climate comfort, for example for vehicle occupants.

The thermoplastic intermediate layer is preferably transparent. The intermediate layer preferably contains at least one plastic, preferably polyvinyl butyral (PVB), ethylene vinyl acetate (EVA), and/or polyethylene terephthalate (PET). The intermediate layer can, however, also contain for example polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylene, polyvinyl fluoride, and/or ethylene tetrafluoroethylene, or copolymers or mixtures thereof. The intermediate layer can be formed by one or even by a plurality of films arranged one over another, wherein the thickness of a film is preferably from 0.025 mm to 1 mm, typically 0.38 mm, 0.76 mm or 0.84 mm. The intermediate layer can preferably be thermoplastic and, after lamination, the inner and outer panes and any other intermediate layers can be bonded to one another. In the sense of the invention, lamination is thus the bonding of the inner pane, intermediate layer and outer pane, along with the integration and fixing of the at least one electrical functional element.

In a further embodiment, the laminated pane can have or comprise a functional intermediate layer, in particular with acoustic damping properties, a wedge-shaped intermediate layer, for example for laminated panes with a HUD function, an intermediate layer that is colored at least in portions and/or an intermediate layer that is tinted at least in portions.

The inner pane and the outer pane contain glass, particularly preferably flat glass, float glass, quartz glass, borosilicate glass, soda-lime glass, or clear plastics materials, preferably rigid clear plastics materials, in particular polyethylene, polypropylene, polycarbonate, polymethyl methacrylate, polystyrene, polyamide, polyester, polyvinyl chloride, and/or mixtures thereof. The laminated pane with an inner pane and an outer pane is preferably transparent, in particular for use of the pane as a windshield on a vehicle or for other uses where high light transmission is desired. In the sense of the invention, “transparent” refers to a pane that has a transmission greater than 70% in the visible spectral range. However, for panes that are not situated in the traffic-related field of vision of the driver, for example, for roof panes, transmission can also be much lower, for example, greater than 5%.

In an advantageous embodiment, the thickness of the inner pane is 0.4 mm to 3.5 mm, preferably 0.9 mm to 2.1 mm. In an advantageous embodiment, the thickness of the outer pane is at least 1.4 mm, preferably at least 1.6 mm. The thickness of the outer pane is preferably a maximum of 4.5 mm, preferably a maximum of 2.1 mm. In this region, the laminated pane has an advantageous mechanical stability and noise-shielding properties, but is still sufficiently thin and light to be used as a windshield. The outer pane, the inner pane, and the thermoplastic intermediate layer can be clear and colorless, but also tinted or colored. In a preferred embodiment, the total transmission through the laminated pane is greater than 70%, in particular if the laminated pane is a windshield. The term “total transmission” relates to the method defined by ECE-R 43, Annex 3, § 9.1 for testing the light transmittance of motor vehicle panes.

The outer pane can preferably have a black print on the inner side in the region near the edge of the glass, in order to, for example, conceal connecting cables, adhesive beads for fastening the pane or one or more electrical functional elements arranged therein from the outside and to provide UV protection.

Furthermore, the invention relates to a method for producing a laminated pane with an integrated electrical functional element, as described above in various embodiments, comprising the steps of
A) providing at least one electrical functional element, wherein the functional element has at least one film, in particular a PE/PC film, with at least one functional surface on which at least one functional layer with at least one electrical component is arranged, wherein at least one electrical module is formed on the functional surface and/or a decorative layer is formed on the film and/or the electrical functional element is or comprises at least one IME component,
B) providing a stacking sequence comprising an outer pane, an inner pane, at least one thermoplastic film arranged therebetween to form the thermoplastic intermediate layer and the at least one electrical functional element,
wherein the at least one electrical functional element is arranged in the stacking sequence in such a way that the electrical module or the IME component is arranged at least partially in a recess or cutout prefabricated for that purpose or in a setback of the inner pane and/or the intermediate layer,
C) laminating the stack sequence to form a laminated pane.

In a further embodiment of the method, the electrical functional element is formed or connected with a system-in-package (SiP) chip and/or with a system-on-chip (SoC), and wherein this chip is arranged in a recess, a cutout or a setback of the inner pane and/or the intermediate layer.

In another embodiment of the method, it is provided that at least one electrically switchable layer, in particular a switchable liquid crystal layer, is formed.

In a further design according to the invention, it is provided that one or more functional layers, in particular an infrared-ray-reflecting layer, an infrared-ray-absorbing layer, a UV-ray-reflecting layer and a UV-ray-absorbing layer are formed. Preferably, these infrared-ray-and UV-ray-reflecting or absorbing layers can be arranged spatially behind the electrical functional element when viewed through the laminated pane in the direction of view from the inner pane to the outer pane; for example, they can be formed and arranged on the inner side of the outer pane or in the intermediate layer, while the electrical functional element is arranged between the intermediate layer and the inner pane, for example. In this way, these functional layers can advantageously protect the electrical functional element from the harmful effects of strong sunlight. Such functional layers are known and described in many ways and can be created in known ways, for example by physical or chemical vapor deposition methods (PVD and CVD) or cathode ray methods (sputtering).

Furthermore, in one embodiment of the method, a functional intermediate layer, in particular an intermediate layer with acoustically damping properties, or an intermediate layer that is colored at least in portions and/or an intermediate layer that is tinted at least in portions, or even a wedge-shaped film can be used to form the intermediate layer.

According to a further embodiment of the method for producing a laminated pane according to the invention, the electrical functional element is connected to a control unit and/or the on-board electronics via connection lines, conductor bars, in particular a CAN bus, LIN bus, MOST bus, FlexRay or automotive Ethernet. In addition or alternatively, the electrical functional element can be functionally connected to other electrical functional elements, electrically switchable layers or components, such as electrical circuits, sensors, antennas, cameras, displays, projectors. If applicable, these can be arranged inside or outside the laminated pane.

The invention also relates to the use of a laminated pane as described above in various designs and embodiments in vehicles for transportation on land, in the air or on water, in particular for motor vehicles, in particular as a roof pane, windshield or side pane. Alternatively, the laminated pane can also be a building glazing.

The various embodiments of the invention can be implemented individually or in any combinations. In particular, the features mentioned above and explained below can be used not only in the combinations indicated, but also in other combinations or on their own, without departing from the scope of the present invention, unless combinations of the embodiments or individual features are described merely as alternatives or are mutually exclusive. Features of the laminated pane and the production method are also included hereby.

In the following, the invention is explained in more detail with the aid of drawings and examples of embodiments. The drawings are exclusively schematic representations and are not true to scale. The drawings and exemplary embodiments do not limit the invention in any way. The following are shown

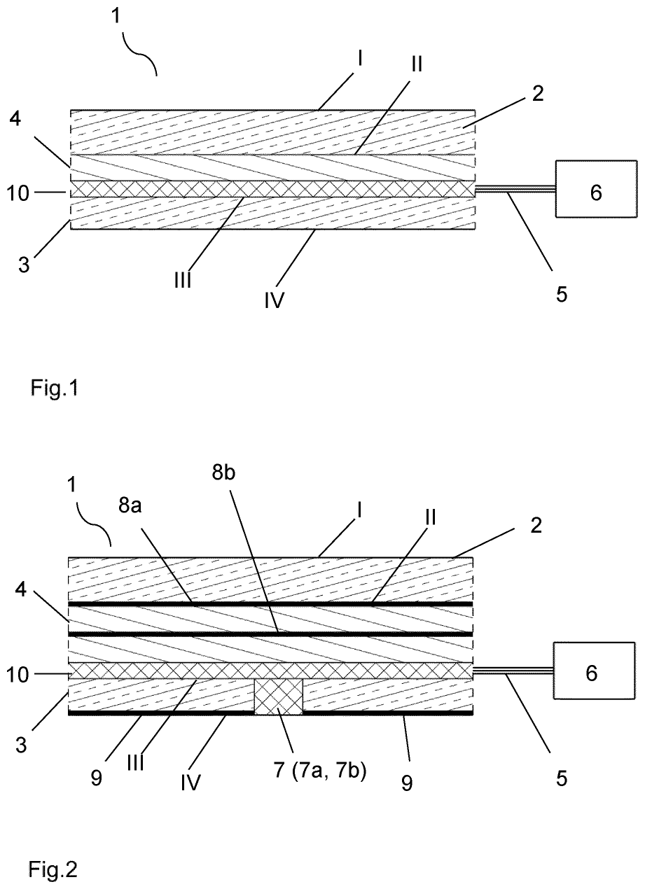

FIG. 1 a cross-section through a laminated pane in the region of the electrical functional element as a film;

FIG. 2 a cross-section through a laminated pane in the region of the electrical functional element in a second embodiment;

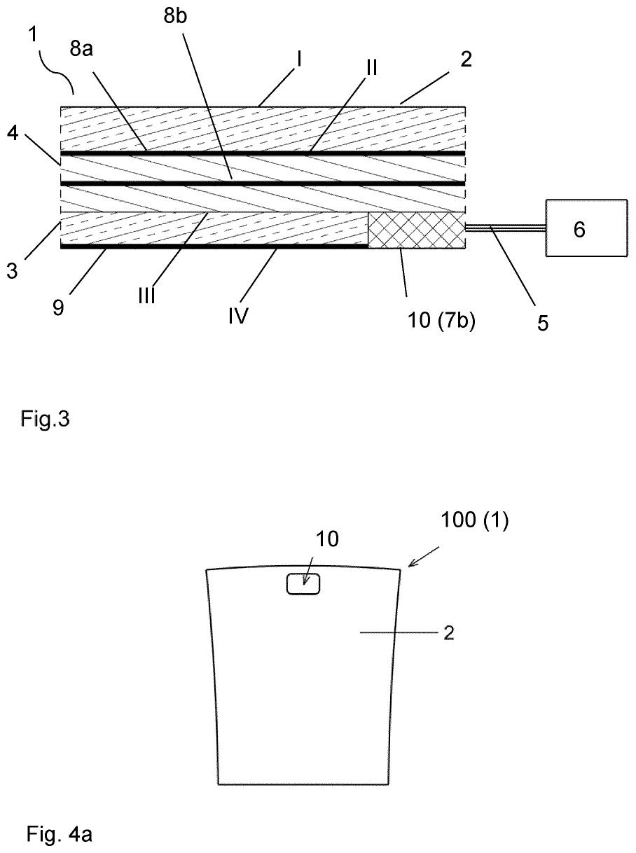

FIG. 3 a cross-section through a laminated pane in the region of the electrical functional element in a third embodiment;

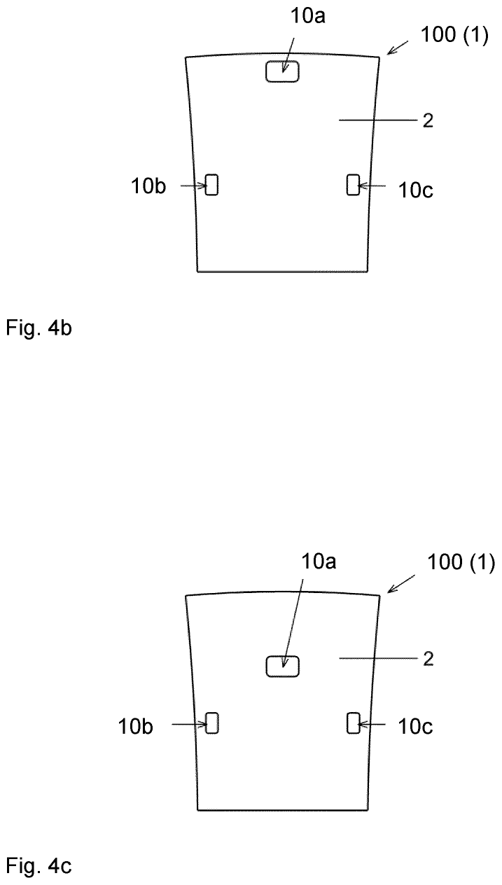

FIG. 4a-c embodiments of a laminated vehicle roof pane,

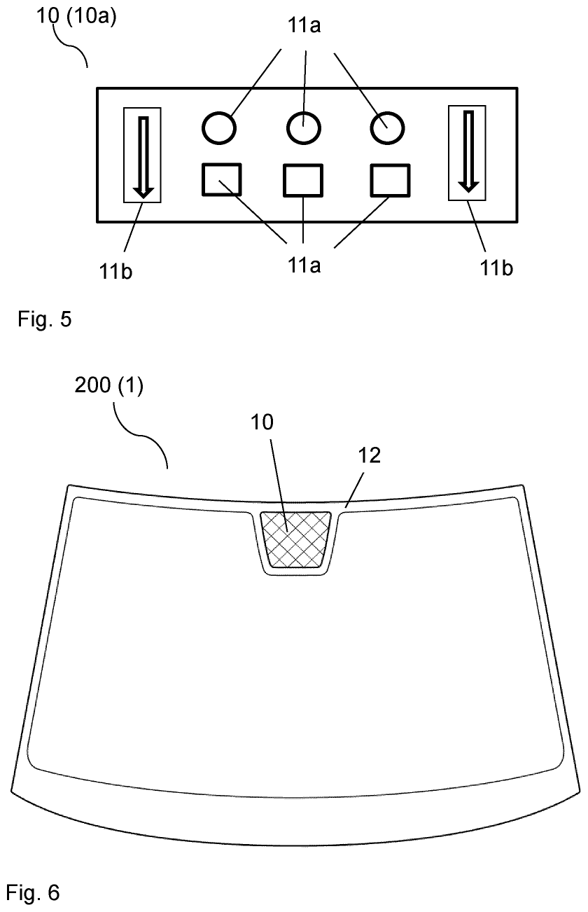

FIG. 5 a schematic plan view of an electrical functional element, configured as an operating device,

FIG. 6 a schematic plan view of a laminated pane according to the invention.

FIG. 1 shows a cross-section through a laminated pane 1 in a region that contains an electrical functional element 10 in film form. The laminated pane 1 has an outer pane 2 with an outer side I and an inner side II and an inner pane 3 with an outer side III and an inner side IV, which are bonded to one another via a thermoplastic intermediate layer 4. In this design, the electrical functional element 10 is configured as a film, i.e. as a functional film, which is embedded between the intermediate layer 4 and the outer side III of the inner pane 3. In one embodiment, the film has at least one functional surface with a functional layer with at least one electrical component and a decorative layer is formed on the film (not shown separately). The electrical component is part of the functional layer. The functional film is preferably a polyester or polycarbonate film. For example, the entire surface or a partial region of the film, on the functional surface and/or on the surface of the film opposite the functional surface, can be provided with a decorative or functional pattern, for example with color, graphics, text, symbols or patterns. The decorative layer can be applied before, at the same time as or after the creating, for example the printing, of the electrical components. In this way, for example, graphics and conductor tracks can be screen printed with known functional inks on thin polyester or polycarbonate films. It is also possible to apply desired or required decorative elements to a carrier film by means of screen or digital printing and to bond this decorative film over its entire surface to the functional film prior to or during lamination to form the laminated pane 1. In other words, the functional film and the decorative film can be used in the stacking sequence for lamination as a film composite or as individual functional and decorative films arranged flat on top of one another. An analogous method is known in the field of in-mold decoration of integrated electronic (IME) components, although according to the invention the forming and back-molding of the films is replaced by the lamination process. Thus, sub-steps of these known methods can be advantageously combined with one another or used to complement one another. The electrical functional element 10 can, for example, be created and provided as a film-shaped, integrated operating device with a decorative, visually appealing and intuitively operable user interface (decorative layer), for example with touch buttons (touch switches) or sliders (sliding switches), as shown schematically in FIG. 5. The decorative layer is thus purposefully applied to the functional film of the electrical functional element 10 on the side facing an observer and, optionally, a potential operator (operating side) and arranged in the laminated pane 1, for example in the direction of a vehicle interior. The electrical functional element 10 is connected to a control unit 6 or the on-board electronics via connecting cables 5, for example via conductor bars.

FIG. 2 shows a cross-section through a laminated pane 1 in the region of the electrical functional element 10 in another embodiment, in which, in a change to the embodiment shown in FIG. 1, an electrical module 7 is arranged and functionally connected as a 3D component on a functional film on the functional surface. Such a module 7 can be a SiP chip, for example, which is arranged in a cutout, such as a hole in the inner pane 3. Here, various chips are combined in a package to form a complete electronic system (SiP). This further contributes to an advantageous component reduction when integrating multiple functions into a laminated pane. Furthermore, in this embodiment, two functional layers 8a, 8b are arranged spatially behind the electrical functional element 10 in the direction of view from the inner pane 3 to the outer pane 2. These functional layers 8a, 8b can, for example, be infrared radiation-shielding layers or UV-protective layers that protect the electrical functional element 10 from the harmful effects of sunlight and can also advantageously improve climate comfort, for example for vehicle occupants. Furthermore, in the embodiment shown, a further functional layer 9, for example a low-E layer as a heat protection layer, is arranged on the inner side IV of the inner pane 3.

FIG. 3 shows a cross-section through a laminated pane 1 with an electrical functional element 10, which is integrated in a setback of the inner pane 3. In particular, the functional element 10 can be an in-mold electronics (IME) component (7b). This can be adapted in its geometric form (for example in its curvature) and shape to the laminated pane and the setback of the inner pane so that it is flush with the inner side IV of the inner pane 3, so that an appealingly even surface is created for the observer. For example, the functional element 10 can be an operating device. Advantageously, IME components can be provided in such a low height and, due to the robust, temperature-stable design, can be easily integrated into the laminated pane 1 in a lamination process. The positioning of the electrical functional element 10 can be selected very flexibly, not only in this embodiment, so that good accessibility and operability, for example, can be advantageously ensured depending on the functionality provided. In addition to elements of an operating device, the IME component 7b can also comprise one or more other electrical modules, such as lighting elements, like reading lamps, or sensors or other functional elements.

FIGS. 4a-c show embodiments of a laminated pane 1 according to the invention as vehicle roof glazing 100 in plan view of the outer pane 2. In FIG. 4a, an integrated electrical functional element 10, for example an IME component configured as an operating device, is arranged between the driver and front passenger. In FIG. 4b, for example, a first operating device 10a is arranged between the driver and front passenger. A second operating device 10b and a third operating device 10c are arranged in the outer region of the rear seats. This arrangement 10b and 10c is particularly suitable for an operating device with an integrated reading lamp. In FIG. 4c, a first operating device 10a is arranged in a more central position of the roof pane 100 between the driver and front passenger along with the passenger row (rear seat bench). In this way, accessibility is provided for all vehicle occupants, if applicable. A second operating device 10b and a third operating device 10c are arranged in the outer region of the rear seats. This arrangement 10b and 10c is particularly suitable for an operating device with an integrated reading lamp. The operating device can be arranged both in an edge region of the laminated pane 1 and in a central region of the laminated pane 1. This makes it possible to achieve optimum positioning for operation by one user.

FIG. 5 shows a schematic plan view of an electrical functional element 10 configured as an operating device 10a. The electronic component of the functional layer is then part of an operating element, for example. For the purposes of the present invention, an operating element is to be understood to mean a region of the user interface that is configured so that a switching function is executed by pressing (touch button 11a) or pressing and a sliding movement (sliding switch/slider 11b). Such operating elements and their possible design and function are known as such.

In FIG. 6, a laminated pane 1 according to the invention is shown in plan view in an embodiment as a windshield 200, for example as a panoramic windshield. The integrated electrical functional element 10 is arranged when installed in the upper, roof-side edge region of the windshield 200 centrally between the driver and front passenger and can, for example, be configured as an operating device. Advantageously, the electrical functional element 10 can be configured with a wide range of variations with respect to spatial and geometric dimensions, and in functional and decorative terms. In this way, it can be flexibly adapted to various functional needs, and to aesthetic requirements, demands and preferences. The functional element 10 can be concealed to the outside, covered and protected from UV light by a cover print 12, for example a black cover print 12 on the edge, which is preferably applied to the inner side II of the outer pane 2.

According to the invention, a compact method for the series production of laminated panes with integrated functional elements in a high-quality, visually appealing design is provided. According to the invention, it is possible, for example, to integrate high-quality control panels, beautifully designed control switch and monitoring elements with an extended range of functions into the laminated pane with great design freedom.

### LIST OF REFERENCE SIGNS

1 Laminated pane
2 Outer pane
3 Inner pane
4 Intermediate layer
5 Connection element (e.g., conductor bars, bus bars)
6 Control unit/on-board electronics
7 Electrical module, in particular electrical 3D component
7a System-in-package (SiP)
7b IME component
8, 8a, 8b Functional layer (IRR/UV protection),
9 Additional functional layers, low-E layer
10 Electrical functional element
10a, 10b, 10c Electrical functional element (operating device)
11a Touch button
11b Slider
12 Cover print
100 Roof pane (laminated pane 1)
200 Windshield (laminated pane 1)
I Outer side of the outer pane
II Inner side of the outer pane
III Outer side of the inner pane
IV Inner side of the inner pane

1. A laminated pane having an outer pane with an outer side and an inner side and an inner pane with an outer side and an inner side, which are bonded to one another via a thermoplastic intermediate layer,
wherein at least one electrical functional element is integrated in the laminated pane, which
has at least one film with at least one functional surface, on which at least one functional layer with at least one electrical component is arranged, wherein at least one electrical module is formed on the functional surface and/or a decorative layer is formed on the film,
and/or which
is or comprises at least one in-mold electronics component,
wherein the electrical module or the in-mold electronics component is at least partially arranged in a recess or cutout prefabricated for this purpose or in a setback of the inner pane and/or the intermediate layer.

2. The laminated pane according to claim 1, wherein the electrical functional element is formed with and/or connected to conductor tracks, electrical circuits, operating elements, sensors, antennas and/or integrated circuits.

3. The laminated pane according to claim 1, wherein the electrical module is a surface-mounted electrical component selected from the group consisting of integrated circuit, resistor, capacitor.

4. The laminated pane according to claim 1, wherein the electrical module is a system-in-package or a system-on-chip, wherein the chip is arranged in a recess, a cutout or a setback of the inner pane and/or the intermediate layer.

5. The laminated pane according to claim 1, wherein the electrical functional element is at least one in-mold electronics component.

6. The laminated pane according to claim 5, wherein the in-mold electronics component is arranged in a cutout prefabricated for this purpose or in a setback of the inner pane.

7. The laminated pane according to claim 1, wherein the electrical functional element is connected via a connection to a control unit and/or the on-board electronics.

8. The laminated pane according to claim 1, comprising at least one electrically switchable layer, which is functionally connected to the electrical functional element.

9. The laminated pane according to claim 1, wherein the electrical functional element is functionally connected to at least one electrically switchable component or module.

10. The laminated pane according to claim 1, comprising one or more functional layers, and/or the intermediate layer is or comprises a functional intermediate layer a wedge-shaped intermediate layer, an intermediate layer that is colored at least in portions and/or an intermediate layer that is tinted at least in portions.

11. A method for producing a laminated pane according to claim 1, comprising:
A) providing at least one electrical functional element, wherein the functional element has at least one film, in particular a PE/PC film, with at least one functional surface on which at least one functional layer with at least one electrical component is arranged, wherein at least one electrical module is formed on the functional surface and/or a decorative layer is formed on the film and/or the electrical functional element is or comprises at least one in-mold electronics component,
B) providing a stacking sequence comprising an outer pane, an inner pane, at least one thermoplastic film arranged therebetween to form the thermoplastic intermediate layer and the at least one electrical functional element,
wherein the at least one electrical functional element is arranged in the stacking sequence in such a way that the electrical module or the in-mold electronics component is arranged at least partially in a recess, or cutout prefabricated for this purpose or in a setback of the inner pane and/or the intermediate layer,
C) laminating the stack sequence to form a laminated pane.

12. The method for producing a laminated pane according to claim 11, wherein the electrical functional element is formed or connected with a system-in-package chip or a system-on-chip and wherein the chip is arranged in a recess, a cutout or a setback of the inner pane and/or the intermediate layer.

13. The method for producing a laminated pane according to claim 11, wherein at least one electrically switchable layer and/or one or more functional layers, an intermediate layer with acoustically damping properties, or an intermediate layer that is colored at least in portions and/or an intermediate layer that is tinted at least in portions, are formed.

14. The method for producing a laminated pane according to claim 11, wherein the electrical functional element is connected via connections, bus conductors to one or more further electrical functional elements, electrically switchable layers, to a control unit and/or the on-board electronics.

15. A method comprising providing a laminated pane according to claim 1 in a vehicle for traffic on land, in the air or on water.

16. The laminated pane according to claim 1, wherein the laminated pane is a vehicle pane.

17. The laminated pane according to claim 7, wherein the electrical functional element is connected via a data connection to a control unit and/or the vehicle electronics.

18. The laminated pane according to claim 8, wherein the at least one electrically switchable layer is a PDLC layer, an LC layer, an electrochromic layer, a luminescent layer, or a layer with SPD or guest host technology.

19. The laminated pane according to claim 9, wherein the electrical functional element is functionally connected to electrical circuits, operating elements, sensors, antennas, imaging and image-recording or acoustic modules, or lighting elements.

20. The laminated pane according to claim 10, wherein the one or more functional layers are an infrared-ray-reflecting layer, an infrared-ray-absorbing layer, a low-E layer, an infrared-ray-absorbing layer and/or a UV-ray-absorbing layer, and/or the functional intermediate layer has acoustically damping properties.
